(19) United States
(12) Patent Application Publication
(10) Pub. No.: US 2013/0236756 A1
(43) Pub. Date: Sep. 12, 2013

(54) LITHIUM BOBBIN CELL WITH CATHODE USING WRAPPED METAL GRID AS CURRENT COLLECTOR

(71) Applicants: Xinrong Wang, Fairport, NY (US); Michael Manna, Canandaigua, NY (US)

(72) Inventors: Xinrong Wang, Fairport, NY (US); Michael Manna, Canandaigua, NY (US)

(73) Assignee: Ultralife Corporation, Newark, NY (US)

(21) Appl. No.: 13/416,363

(22) Filed: Mar. 9, 2012

(51) Int. Cl. H01M 4/72; H01M 4/00

(52) U.S. Cl. 429/94

(57) ABSTRACT

Improved structure and performance are disclosed for lithium cylindrical primary and secondary bobbin cells having an improved cathode and current collector. This collector can be a metal screen, mesh or grid, and may further be treated with carbon or cathode mix components and then wrapped around the cathode and embedded into its surface. This metal grid collector reduces cell impedance, and increases discharge rate capability as well as low temperature performance. The cathode for these cells is surrounded by the anode and may also have a hole through its center to provide improved manufacturability and reduced cost for the cells.

This invention relates to the construction and operation of cylindrical lithium bobbin cells with a cathode featuring an improved current collector. The collector can be a metal screen, mesh or grid as well as a structure treated with carbon or cathode mix components, and is wrapped around the cathode and embedded into its surface. This metal grid collector results in improved cell performance by reducing cell impedance, increasing discharge rate capability and low temperature performance. The cathode rod for these cells may also have a hole through its center which results in improved manufacturability of these cells.

### BACKGROUND AND SUMMARY

The dissemination of and advances in various portable electronic equipment, such as note-book computers and video cameras, has been accompanied by heightened demand for higher performance batteries as power sources for such devices, with attention being focused particularly on lithium batteries and lithium ion secondary batteries. As lithium batteries and lithium ion secondary batteries have high voltages, their energy density is also high, contributing significantly to the down-sizing and reduction in weight of portable electronic equipment.

Further movement towards smaller, lighter and more sophisticated portable electronic equipment, however, has given rise to even stronger demands for high performance batteries, and in turn a need to boost energy density, even in lithium batteries and lithium ion secondary batteries, as well as reliability and safety. One such portable electronic system is a transponder system as may be used for remote metering of utilities such as water, natural gas and the like. Such systems require high levels of current during the relatively short periods when the transponder is activated for transmitting measurement data, but low levels of current during the long periods of non-measurement, thus representing what may be characterized as a pulse current application. In addition since these measurement systems are often located outside or in areas of building and homes that may not have power or heat available, they require portable electronic systems, particularly systems that are operable over wide temperature ranges.

The most widely used packaging for lithium batteries is the cylindrical cell, which is found in three basic types of construction: bobbin, moderate rate and spiral. In the metering industry, the requirements for batteries are small size, high capacity, wide operating temperature and mediate discharge rate capability as well as low cost. Currently, lithium thionyl chloride (Li—SOCl₂) primary cells are widely used based on the wide operating temperature range and low cost. However, lithium thionyl chloride primary cells have some disadvantages such as safety concern due to its chemistry and voltage delay at the beginning of discharge. On the other hand, lithium manganese dioxide (Li—MnO₂) primary cells have potential applications in the metering industry due to their safety and the lack of a voltage delay. The spiral wound Li—MnO₂ primary cells have the advantage of high discharge rate capability, but have a high cost due to a cathode coating process and other manufacture processes. Bobbin Li—MnO₂ primary cells have the advantage of low cost, but they lack a high discharge rate capability. In order to meet the requirements of batteries used for metering applications a bobbin-type cell design is employed. More specifically, in in one embodiment a bobbin-type Li—MnO₂ primary cell is produced with a unique cathode configuration and thereby provides both the advantages of high performance and low cost.

The cell construction type determines the amount of common surface area between the anode and the cathode. The amount of electrode surface area is dependent on the configuration of the cell. The bobbin cell typically has a small common surface area between the anode and the cathode. Basically it consists of one cylinder of cathode surrounded by one cylinder of anode material. The advantages of this type of cell are its low manufacturing cost, low self discharge rate, and no safety fuse requirement. The main disadvantage of these cells is their low rate discharge capability due to low common surface area.

The embodiments described herein relate to lithium cylindrical primary and secondary bobbin cells, and the constructio0n thereof. Such cells include a cathode featuring an improved current collector. This collector can be a metal screen, mesh or grid, and further includes collectors treated with carbon or cathode mix components, which is wrapped around the cathode and embedded into its surface. The metal grid collector results in improved cell performance by reducing cell impedance, as well as increasing discharge rate capability and low temperature performance. The cathode rod for these cells may also have a hole through its center which further improves manufacturability of the bobbin-type cells.

In accordance with an aspect of the disclosed embodiments, there is provided a bobbin type lithium electrochemical cell, including: a cathode, said cathode wrapped and embedded with a metal grid current collector; and a lithium anode, located outside of an extending around at least a substantial portion of said cathode. In accordance with another aspect of the disclosed embodiments, there is also a separator between the cathode and the anode, which is insulating for electron transport, yet allows non-aqueous liquid electrolyte, including lithium ions, to be transported through the separator via its porous structure.

In accordance with another aspect of the disclosed embodiments, there is provided a battery having a bobbin type lithium electrochemical cell, including: a cathode, said cathode wrapped and embedded with a metal grid current collector; a lithium anode, located outside of an extending around at least a substantial portion of said cathode; a separator between the cathode and anode, which insulates against electron transport yet allows non-aqueous liquid electrolyte, including lithium ions, to move through its porous structure. Although the disclosed embodiments may be constructed in a number of battery types, a bobbin embodiment further includes a metal housing or can enclosing said anode, separator, cathode and electrolyte. Furthermore, there is a metal cathode tab connecting the current collector to a metal pin terminal, wherein the pin terminal is insulated from the metal can.

### BRIEF DESCRIPTION OF THE DRAWINGS

FIG. 1 is a cross-section drawing depicting a bobbin-type lithium primary cell using a cathode with metal grid wrapping;

FIGS. 2A and 2B respectively depict cut-away cross-sectional and full perspective views of a solid bobbin cell cathode with metal grid wrapping;

FIGS. 3A and 3B respectively depict cut-away cross-sectional and full perspective views of a hollow bobbin cell cathode with metal grid wrapping;

FIGS. 4A and 4B respectively depict cut-away cross-sectional and full perspective views of a hollow bobbin cell cathode with a treated metal grid wrapping;

FIG. 5 is a graph depicting the discharge profile of a bobbin cell (Q-4) using a cathode not wrapped with a metal grid current collector, at 23° C.;

FIG. 6 is a graph depicting the discharge profile of the bobbin cell using a cathode wrapped with a metal grid current collector at 23° C.; and

FIG. 7 is a graph depicting the discharge profile of the bobbin cells Q-10 (cathode without metal grid current collector) and S-13 (cathode with metal grid current collector) at −40° C.

The disclosed embodiments will be described below, however, it will be understood that there is no intent to limit such embodiments. On the contrary, the intent is to include all alternatives, modifications, and equivalents as may be included within the spirit and scope of the appended claims.

### DETAILED DESCRIPTION

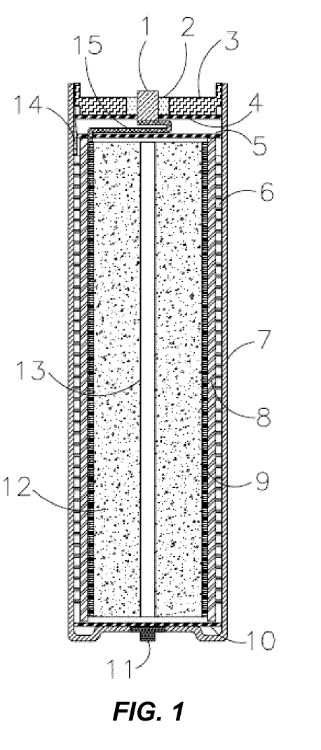

This disclosure relates to lithium cylindrical bobbin cells, and the construction thereof. Such cells may be primary or secondary cells, and include a cathode comprising an improved current collector. As will be described in more detail below, the collector can comprise a metal screen, mesh or grid, and may be treated with carbon or cathode mix components. The collector is wrapped around the cathode and embedded into its surface. This metal grid collector results in improved cell performance by reducing cell impedance, increasing discharge rate capability, as well as improving low temperature performance over conventional cells of the same type. More specifically the bobbin cell, as depicted in FIG. 1, comprises a cylindrical metal can 7 having a lithium anode 6 disposed therein. In one embodiment, the anode may contact the inner wall of the metal can, although in alternative designs it may not contact the wall. In one of the disclosed embodiments, the anode may be lithium or a lithium alloy. The alloy may be lithium combined with one or more metals including magnesium, aluminum and silicon. Housing or can 6 may also include a fill port 11, though which an electrolyte may be added during assembly of the cell.

Although several of the examples below discuss particular cell sizes, it will be appreciated that the disclosure herein is applicable to various cell sizes, including lithium cylindrical bobbin cells, in which the size is: AAA, AA, A, 18650, 19650, C, D and DD as well as their varieties such as 2/3A, 1/2A, 5/4C and others. Also, although described relative to a bobbin-type cell design, it should be appreciated that aspects of the disclosed embodiments are equally applicable to prismatic type cells or pouch type cells.

Continuing with the bobbin-type cell of FIG. 1, the central cavity of the metal can or housing is lined with an appropriate separator 8 which not only separates the lithium anode 6 from the cathode materials 12, but also is designed for maximum physical integrity and, may further exhibit a thermal shutdown capability. The separator can be formed from any of a number of materials. The typical separator materials used in lithium primary and secondary cells includes a thermal shutdown functional separator in one embodiment, such as a laminated structure of polypropylene and polyethylene. For non-thermal shutdown components, separators such as a single layer of polypropylene or polyethylene, fiberglass, paper and other materials, as well as a combination of the above may be used as separators. In one embodiment, the separator between the cathode and the anode acts as an insulator for electron transport, yet allows non-aqueous liquid electrolyte, including lithium ions, to be transported through the separator via its porous structure.

The cathode, in the shape of a solid rod or a cylinder as will be described below, is wrapped and embedded with the metal grid current collector 9 and is filled with the active cathode materials 12 which include the active material, a conductive agent and a binder. A metal cathode tab 15 connects the metal grid cathode collector to the metal pin or cell terminal 1, which is insulated by a glass or similar insulating material 2 from the outside metal can, and held in place by the metal cap 3. A metal anode tab 14 connects the lithium anode 6 to the outside metal can. In addition the appropriate top and bottom insulators 4, 5, and 10 are shown within the can. Also depicted is a central through-hole 13 in the cathode which may or may not be present. The cathode materials may include manganese dioxide, iron disulfide, carbon fluoride, cobalt oxide, iron phosphate and combinations thereof.

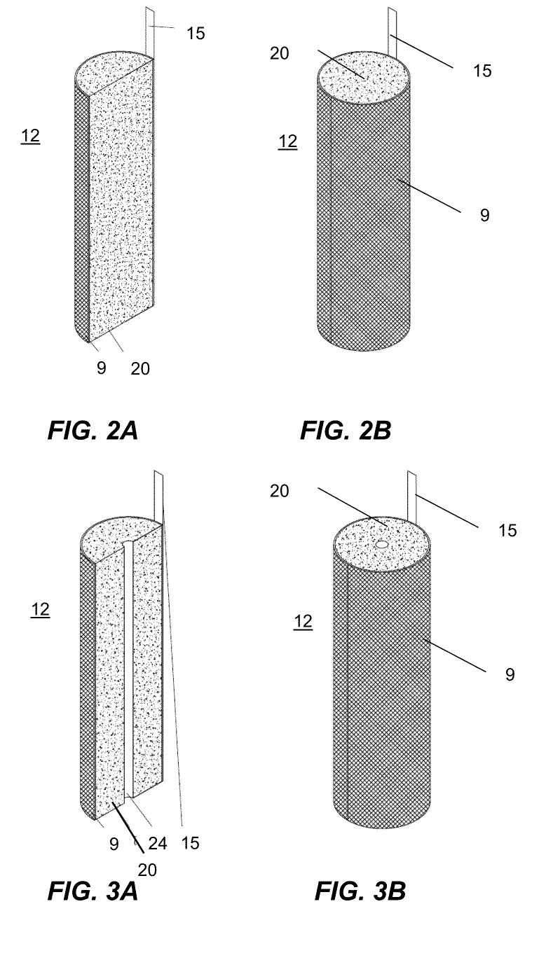

Referring also to FIGS. 2A-2B and 3A-3B, these figures depict the cathode in both a solid rod configuration such as FIGS. 2A and 2B, and a hollow cylinder configuration such as FIGS. 3A and 3B. In either embodiment, the cathode is wrapped with the metal grid current collector. The cathode current collector can be a metal screen, metal mesh or metal grid made from materials such as copper, aluminum, steel and stainless steel, nickel, titanium and alloys thereof. The cathode current collector may also be a metal grid specially treated with other conductive materials, such as carbon or a cathode composition (e.g., MnO₂/conductive agent/binder, CFₓ—MnO₂/conductive agent/binder, CFₓ/conductive agent/binder, FeS₂/conductive agent/binder and others).

In each case the metal grid 9 is connected to a metal tab 15 and the cathode is filled with a cathode mix 20 containing active material, a conductive agent and a binder. The conductive agent comprises carbon black, graphite, metal powder and conductive polymer as well as combinations thereof. The binder material may include polyvinylidene fluoride (PVDF), polytetrafluoroethylene (PTFE), rubber and one or more of various polymers as well as combinations thereof.

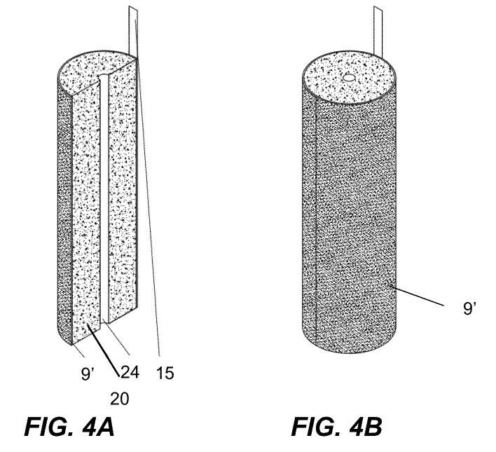

FIGS. 4A-4B depict a hollow cathode 12 having a central through hole 24. The cathode remains wrapped with the metal grid current collector 9′ that is specially treated with carbon or cathode mix components as noted above. The cathode mix materials are noted above and may be formed by extrusion or press as a paste or composite that is then dried. As will be appreciated the hollow-cylinder configuration for the cathode depicted in FIGS. 3A-3B may provide an advantage relative to drying the cathode mix due to the ability for air to circulate through the hole 24.

The electrolyte may be or comprise a non-aqueous solution of a lithium salt and a solvent. The lithium salts that are suitable include LiAsF₆, LiPF₆, LiBF₄, LiClO₄, Lil, LiBr, LiAlCl₄, Li(CF₃SO₃), LiN(CF₃SO₂)₂, LiB(C₂O₄)₂ and LiB(C₆H₄O₂)₂. The concentration of the salt in the electrolyte has a range from about 0.1 to about 1.5 moles per liter. The solvents may comprise one or a mixture of organic chemicals that include carbonate, nitrile and phosphate and include ethylene carbonate, propylene carbonate, 1,2-Dimethoxyethane, tetrahydrofuran, 1,3-dioxolane, ethyl methyl carbonate, butylene carbonate, dimethyl carbonate, diethyl carbonate, gamma-butyrolactone, acetonitrile, triethylphosphate and trimethylphosphate.

### EXAMPLES

The practice of one or more aspects of the disclosed embodiments are illustrated in more detail in the following non-limiting examples.

### Example I

A lithium bobbin cell (Q-4) was constructed using a cell can containing a lithium anode, a separator between an anode and a cathode and then filled with electrolyte, where a cathode bobbin rod contained active cathode materials, a conductive agent and binder but no metal grid wrapped outside, a metal pin or tube connecting to a positive metal pin of the (glass-to-metal) GM seal as a cathode current collector in the cathode center. A second lithium bobbin cell (S-12) was identically constructed as FIG. 1 except for a metal grid current collector wrapped around and embedded into the cathode, which was connected to a positive metal pin of the GM seal using a metal tab.

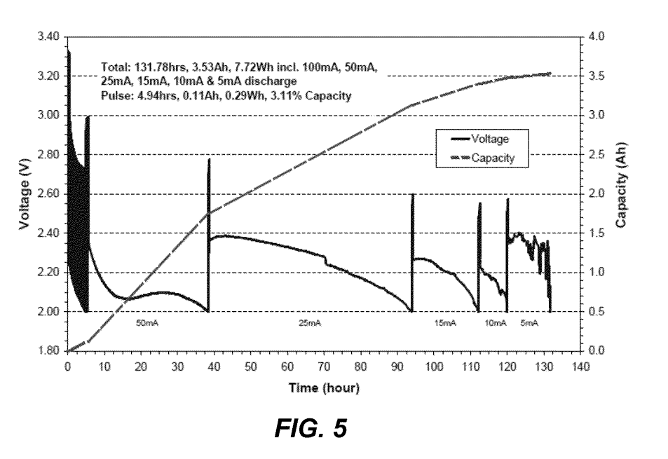

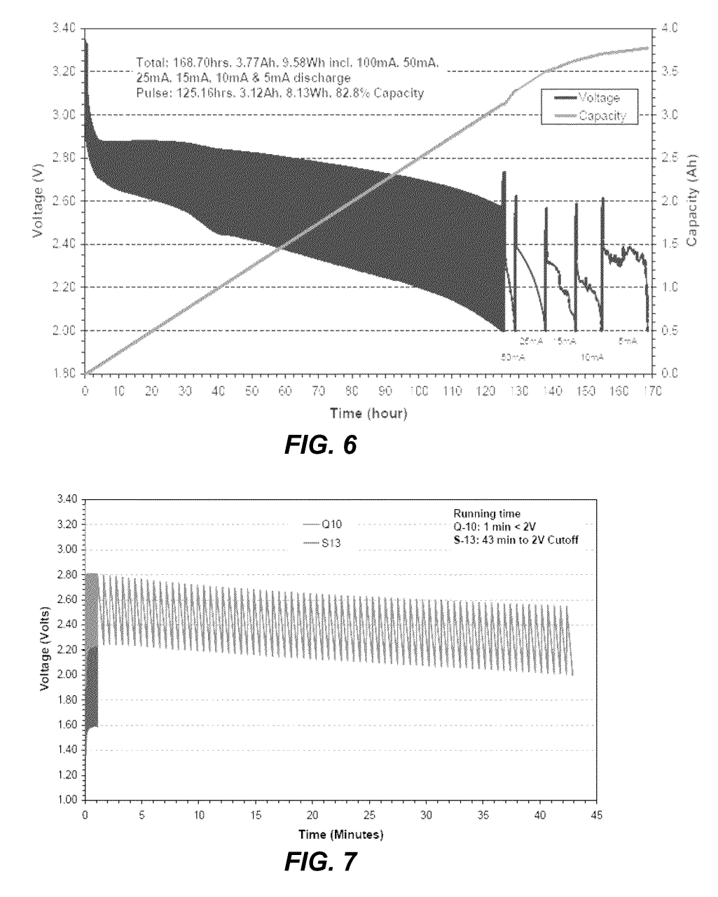

To predict the long term performance of these cells, an accelerated pulse test was run in which each cell was cyclically discharged at a 125 milliamp current for 30 milliseconds followed by a 15 milliamp current discharge for 300 milliseconds. When a cutoff voltage of 2 volts was reached by the cell, the output current was then limited to 50, 25, 15, 10 and 5 milliamps successively. The resultant plots of voltage versus time for cells Q-4 and S-12 are given in FIGS. 5 and 6 respectively along with a capacity. These show a greatly increased capacity for the cell featuring a metal grid wrapped cathode (S-12) of 82.8% as compared to 3.11% for the non metal grid cathode cell (Q-4). Thus, the configuration of the S-12 cell resulted in an improvement of at least 10× in discharge capability over that of the conventional Q-4 design, although it will be appreciated that performance improvement levels may be depending on the size (e.g., AAA, AA, A, C, D) and type of cells (e.g., bobbin, pouch, prismatic).

The resultant data indicates that the S-12 cell including a metal current collector in the cathode improved performance versus a similar cell using central metal pin as collector without the metal grid wrapping outside cathode, and extended the discharge time well beyond 10 hours as observed for the Q-4 cell. In fact, the cell exhibited a discharge time in the accelerated cyclic pulse testing of at least about 100 hours and actually on the order of about 125 hours.

### Example II

In addition, the effect of the new metal wrapped cathode at low temperatures was evaluated. Two cells similar to those described relative to Example I were constructed: Q-10—a lithium bobbin cell without the metal grid wrapped cathode, and S-13—a lithium bobbin cell with the metal grid wrapped cathode were tested at −40° C. In this case both cells were exposed to an 8 hour soak at −40° C., then a cyclic pulse discharge test using 125 milliamps for 30 milliseconds followed by 15 milliamps for 300 milliseconds. The resultant plot of voltage versus time for cells Q-10 and S-13 is given in FIG. 7, which shows the resultant running times to a 2 volt cutoff. The cell featuring a metal grid wrapped cathode (S-13) shows a much longer running time of 43 minutes above 2 volt of running voltage as compared to approximately 1 minute of running voltage to drop to less than 2 volts for the cell without the metal grid wrapped cathode (Q-10).

### Example III

Two lithium bobbin cells were constructed using the metal wrapped and embedded cathode current collector. In one cell, the cathode featuring a hole through the center of the cathode mix was used versus no center hole in the second cell. In the process of manufacture each cell was filled with the cathode mix after the cathode bobbin mix dried. In the case of the cathode featuring a hole through its center, the drying times of the cathode were greatly reduced from about 14 hours to less than about 3 hours at the same elevate temperature between 150° C. to 300° C., thus improving productivity of these cells.

It will be appreciated that various of the above-disclosed embodiments and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. A bobbin type lithium electrochemical cell, including:
a cathode, said cathode wrapped and embedded with a metal grid current collector;
a lithium anode, located outside of an extending around at least a substantial portion of said cathode;
a separator, located between cathode and anode, electrically insulating said cathode from said anode;
a metal housing enclosing said anode, cathode and separator; and
a non-aqueous electrolyte filled inside the metal housing.

2. The cell according to claim 1, wherein said current collector comprises a metal mesh.

3. The cell according to claim 1, wherein said current collector comprises a metal screen.

4. The cell according to claim 1, wherein said current collector includes a metal selected from the group consisting of: copper, aluminum, steel and stainless steel, nickel, titanium and their alloys.

5. The cell according to claim 1, wherein said current collector is treated with carbon.

6. The cell according to claim 1, wherein the said current collector is treated with cathode mix materials.

7. The cell according to claim 1, wherein said cathode includes an active material selected from the group consisting of: manganese dioxide (MnO₂), carbon fluoride (CFₓ), Iron disulfide (FeS₂), cobalt oxide (CoO₂), iron phosphate

8. The cell according to claim 7, further including a conductive agent and binder.

9. The cell according to claim 1, wherein said cathode is generally in the shape of a cylinder

10. The cell according to claim 9, wherein said cylinder is hollow.

11. The cell according to claim 1, wherein the said electrochemical cell is of a size selected from the group consisting of: AAA, AA, A, 18650, 19650, C, D, DD, 2/3A, 1/2A, and 5/4C.

12. The cell according to claim 1, wherein said cell is a primary cell.

13. The cell according to claim 1, wherein said anode includes lithium.

14. The cell according to claim 1, wherein said separator is selected from the group consisting of: a shutdown separator; a non-shutdown separator such as trilayer of polypropylene-polyethylene-polypropylene, a single layer polypropylene and single layer polyethylene, a polymer separator, and a fiberglass separator.

15. The cell according to claim 1, wherein said electrolyte includes a nonaqueous solution of a lithium salt and a solvent, wherein the lithium salt is selected from the group consisting of: LiAsF₆, LiPF₆, LiBF₄, LiClO₄, Lil, LiBr, LiAlCl₄, Li(CF₃SO₃), LiN(CF₃SO₂)₂, LiB(C₂O₄)₂ and LiB(C₆H₄O₂)₂.

16. The cell according to claim 15, wherein a concentration of the lithium salt in the electrolyte has a range from about 0.1 to about 1.5 moles per liter.

17. The cell according to claim 1, wherein the electrochemical cell exhibits a discharge rate capability, at room-temperature and low-temperature, of at least ten times the capability of a conventional bobbin cell.

18. The cell according to claim 1, further comprising a metal cathode tab connecting the current collector to a metal pin terminal, said terminal being insulated from said metal housing.
